(19) United States
(12) Patent Application Publication
(10) Pub. No.: US 2025/0365531 A1
(43) Pub. Date: Nov. 27, 2025

(54) ACOUSTIC OPTIMIZATION OF LOUDSPEAKER MODULES

(71) Applicant: HOLOPLOT GMBH, Berlin (DE)

(72) Inventor: Luca LIEBICH, Berlin (DE)

(73) Assignee: HOLOPLOT GMBH, Berlin (DE)

(21) Appl. No.: 19/081,474

(22) Filed: Mar. 17, 2025

Related U.S. Application Data
(60) Provisional application No. 63/651,699, filed on May 24, 2024.

(51) Int. Cl. H04R 1/28; H04R 1/02; H04R 1/24; H04R 3/14; H04R 5/02

(52) U.S. Cl. CPC H04R 1/2811; H04R 1/025; H04R 1/24; H04R 3/14; H04R 5/02

(57) ABSTRACT

Systems, methods, and apparatuses can include multi-dimensional loudspeaker modules having wave field synthesis (WFS) and/or beamforming capabilities. These systems, methods, and apparatuses can emit precisely controlled sound waves in a three-dimensional space, such as a venue, to create highly localized and customizable audio zones. These systems, methods, and apparatuses can include a Helmholtz resonator. Generally, the sound waves emitted by these systems, methods, and apparatuses can cause the Helmholtz resonator to oscillate to generate sound waves that interfere with the sound waves emitted by these systems, methods, and apparatuses. These systems, methods, and apparatuses can advantageously control the sound waves emitted by the Helmholtz resonator to constructively and/or destructively interfere with the sound waves emitted by these systems, methods, and apparatuses.

### CROSS-REFERENCE TO RELATED APPLICATIONS

The present application claims the benefit of U.S. Provisional Patent Application No. 63/651,699, filed May 24, 2024, which is incorporated herein by reference in its entirety.

### BACKGROUND

Loudspeaker modules have evolved into advanced sound systems designed to offer unprecedented control over audio propagation, making them ideal for large-scale venues like concert halls, theaters, and even theme parks. These loudspeaker modules often incorporate numerous loudspeaker drivers in a multi-layered matrix configuration which allows for precise sound control across both horizontal and vertical axes. This design enables these loudspeaker modules to manage complex audio environments, delivering clear and immersive sound to every seat, even in challenging acoustic conditions. These loudspeaker modules have started utilizing beamforming and wave field synthesis (WFS) to create multiple audio beams, each independently controllable, which helps avoid reverberation and provides uniform coverage across large areas. Each driver in these loudspeaker modules is individually powered and processed, resulting in unparalleled sound fidelity and control.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1A and FIG. 1B illustrate a partial section view of a first exemplary loudspeaker module according to some exemplary embodiments of the present disclosure.

FIG. 2 is a more detailed partial sectional view of the first exemplary loudspeaker module that further illustrates an exemplary Helmholtz resonator that can be implemented within the first exemplary loudspeaker module according to some exemplary embodiments of the present disclosure.

FIG. 3A and FIG. 3B graphically illustrate exemplary tuning of the exemplary loudspeaker module according to some exemplary embodiments of the present disclosure.

FIG. 4A and FIG. 4B illustrate a partial sectional view of a second exemplary loudspeaker module according to some exemplary embodiments of the present disclosure.

FIG. 5 illustrates a partial sectional view of a third exemplary loudspeaker module according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

### Beamforming and Wave Field Synthesis (Wes)

Before describing exemplary loudspeaker modules, beamforming and wave field synthesis (WFS) are to be generally discussed. Beamforming, WFS, and/or any combination thereof can be used to precisely control the direction, shape, and placement of various sound waves in a three-dimensional space, for example, a venue, to create immersive audio experiences. In some embodiments, the venue can represent a music real-world venue, for example, a music theater, a music club, and/or a concert hall, a sporting real-world venue, for example, an arena, a convention center, and/or a stadium, and/or any other suitable real-world venue that will be apparent to those skilled in the relevant art(s) without departing the spirit and scope of the present disclosure. Although these exemplary loudspeaker modules are to be described herein in terms of venues, those skilled in the relevant art(s) will recognize that these exemplary loudspeaker modules can be used in other spaces, such as public transportation hubs, corporate facilities, educational facilities, museums and exhibition spaces, and/or shopping centers and malls, among others to provide some examples, without departing from the spirit and scope of the present disclosure. Generally, wave field synthesis (WFS) represents a spatial audio rendering technique that allows sound fields to be created and controlled with precision. Unlike conventional stereo or surround sound systems which rely on discrete speaker placements in the three-dimensional space and/or psychoacoustic phenomena to simulate spatial sound, the exemplary loudspeaker modules described create sound waves that seem to originate from virtual sound sources in the three-dimensional space. These exemplary loudspeaker modules can emit sound waves having precisely controlled phases and/or amplitudes to advantageously control how these sound waves combine, shaping the direction, focus, and spread of these sound waves in the three-dimensional space to effectively generate sound waves that appear to originate from these virtual sound sources. These exemplary loudspeaker modules can include one or more drivers that are individually controlled in phase and/or amplitude that are combined by these exemplary loudspeaker modules to effectively generate these sound waves. The exemplary loudspeaker modules described herein can simulate sound sources that appear to emanate from specific locations in the three-dimensional space regardless of the listener's position. Beamforming allows the exemplary loudspeaker modules described herein to control and direct sound in specific focused beams. These loudspeaker modules can deliver sound to targeted areas or listeners within the three-dimensional space with minimal interference or unwanted sound dispersion. The exemplary loudspeaker modules described herein can further control the phase and/or the amplitudes of the sound waves emitted by each loudspeaker to create narrow or wide beams of sound that are aimed at specific locations with the three-dimensional space to provide unprecedented control over sound placement. These loudspeaker modules can generate focused beams of sound that can be directed to specific listening zones, while beneficially minimizing interference and/or reflections in unwanted areas. And the exemplary loudspeaker modules described herein can precisely control the shape and the intensity of the sound waves at these specific listening zones.

### Overview

Systems, methods, and apparatuses can include multi-dimensional loudspeaker modules having wave field synthesis (WFS) and/or beamforming capabilities These systems, methods, and apparatuses can emit precisely controlled sound waves in a three-dimensional space, such as a venue, to create highly localized and customizable audio zones. These systems, methods, and apparatuses can include a Helmholtz resonator can include a Helmholtz resonator. Generally, the sound waves emitted by these systems, methods, and apparatuses can cause the Helmholtz resonator to oscillate to generate sound waves that interfere with the sound waves emitted by these systems, methods, and apparatuses. These systems, methods, and apparatuses can advantageously control the sound waves emitted by the Helmholtz resonator to constructively and/or destructively interfere with the sound waves emitted by these systems, methods, and apparatuses.

### First Exemplary Loudspeaker Module

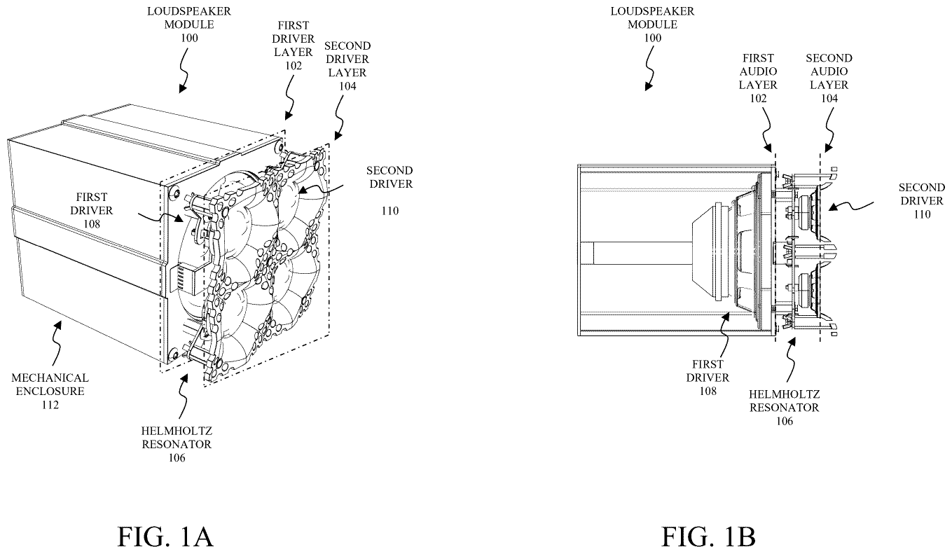

FIG. 1A and FIG. 1B illustrate a partial section view of a first exemplary loudspeaker module according to some exemplary embodiments of the present disclosure. FIG. 1A graphically illustrates a perspective view of a loudspeaker module 100 and FIG. 1B graphically illustrates a side view of the loudspeaker module 100. In the exemplary embodiment illustrated in FIG. 1A and FIG. 1B, the loudspeaker module 100 represents a multi-dimensional loudspeaker module having wave field synthesis (WFS) and/or beamforming capabilities. In some embodiments, the loudspeaker module 100 can emit precisely controlled sound waves in a three-dimensional space, such as the venue described herein, to create highly localized and customizable audio zones. In some embodiments, multiple loudspeaker modules 100 can be coupled together in a horizontal direction and/or a vertical direction to form a loudspeaker module. As illustrated in FIG. 1A and FIG. 1B, the loudspeaker module 100 includes a first driver layer 102 and a second driver layer 104. And as illustrated in FIG. 1A and FIG. 1B, the first driver layer 102 and the second driver layer 104 can be configured and arranged to form a Helmholtz resonator 106 that is situated between these two driver layers, for example, within one or more openings, holes, voids, cavities, hollows, vents, or the like between the first driver layer 102 and the second driver layer 104. In some embodiments, the Helmholtz resonator 106 can further include one or more openings, holes, voids, cavities, hollows, vents, or the like within the second driver layer 104. Generally, the sound waves emitted by the first driver layer 102 and/or the second driver layer 104 can cause the Helmholtz resonator 106 to oscillate to generate sound waves that interfere, for example, constructively and/or deconstructively, with the sound waves emitted by the first driver layer 102 and/or the second driver layer 104. In these embodiments, the loudspeaker module 100 can advantageously control the sound waves emitted by the Helmholtz resonator 106 to constructively and/or destructively interfere with the sound waves emitted by the first driver layer 102 and/or the second driver layer 104 as described herein.

In some embodiments, the first driver layer 102 represents an inner, first driver layer having one or more first drivers 108, also referred to as loudspeakers. In some embodiments, the one or more first drivers 108 can include one or more low-frequency drivers, such as one or more mid-range speakers, one or more woofers, and/or one or more subwoofers to provide some examples. In some embodiments, the one or more first drivers 108 can be situated within a mechanical enclosure 112, for example, a sealed enclosure or a ported enclosure. In these embodiments, the mechanical enclosure 112 can be implemented using dense, rigid materials, such as one or more metals, one or more plastic materials, one or more resin materials, one or more composite materials, one or more ceramic materials, and/or one or more fiberglass materials, among others, to provide some examples. Generally, the mechanical enclosure 112 can shape the quality, the efficiency, and/or the precision of the sound waves generated by the one or more first drivers 108. In some embodiments, the mechanical enclosure 112 can be beneficially designed to minimize sound distortions and prevent unwanted vibrations in the loudspeaker module 100. In these embodiments, the mechanical enclosure 112 can be characterized as containing sound waves emitted from the backside, referred to as back waves, of the one or more first drivers 108 to prevent these back waves from interfering with sound waves emitted from the frontside, referred to as front waves, of the one or more first drivers 108. In some embodiments, the one or more first drivers 108 can be situated within an internal cavity, also referred to as an internal volume, of the mechanical enclosure 112. In these embodiments, the size and/or the shape of the internal cavity can affect the acoustic characteristics of the one or more first drivers 108, for example, their frequency response and/or overall sound quality. In some embodiments, the mechanical enclosure 112 can include a flat panel, or a nearly-flat panel, often referred to as a baffle, for mounting the one or more first drivers 108 to the mechanical enclosure 112. In these embodiments, the one or more first drivers 108 can be secured to the baffle using various fasteners, such as nuts, screws, bolts, rivets, pins, and/or lags, among others, to provide some examples. In some embodiments, sealant or other gaskets can be utilized to secure the one or more first drivers 108 to the baffle to, for example, prevent air leaks and minimize vibrations that can affect sound quality.

In some embodiments, the second driver layer 104 represents an outer, second driver layer having one or more second drivers 110. In some embodiments, the one or more second drivers 110 can include one or more high-frequency drivers, such as one or more super tweeters, and/or one or more tweeters, to provide some examples. In some embodiments, the one or more second drivers 110 can be mounted onto a carrier plate that can be characterized as providing a flat, or near flat, stable surface for mounting the one or more second drivers 110. In these embodiments, the carrier plate can be designed in such a manner that it obstructs the sound outlet of the one or more first drivers 108 as little as possible. In these embodiments, the carrier plate can be implemented using rigid materials, such as one or more metals, one or more plastic materials, one or more resin materials, one or more composite materials, one or more ceramic materials, and/or one or more fiberglass materials, among others, to provide some examples. In some embodiments, the carrier plate can be integrated with one or more sound guides to assist in directing the sound waves emitted by the one or more second drivers 110. Generally, the one or more sound guides are integrated onto the carrier plate to optimize performance of the one or more second drivers 110. In some embodiments, the one or more second drivers 110 can be installed in corresponding sound guides from among the one or more sound guides to manipulate the path and dispersion of the sound waves emitted by the one or more second drivers 110 to optimize performance of the one or more second drivers 110. In these embodiments, the one or more sound guides can be implemented using acoustic horns, waveguides, and/or diffusers, among others. In these embodiments, the one or more sound guides can be implemented using rigid materials, such as one or more metals, one or more plastic materials, one or more resin materials, one or more composite materials, one or more ceramic materials, and/or one or more fiberglass materials, among others, to provide some examples.

As illustrated in FIG. 1A and FIG. 1B, the Helmholtz resonator 106 can include openings, holes, voids, cavities, hollows, vents, or the like that are formed between the first driver layer 102 and the second driver layer 104 and one or more openings, holes, voids, cavities, hollows, vents, or the like within the second driver layer 104. In some embodiments, the Helmholtz resonator 106 can beneficially control the sound waves emitted by the first driver layer 102 and/or the second driver layer 104. In these embodiments, the Helmholtz resonator 106 can interfere, for example, constructively and/or deconstructively, the sound waves emitted by the first driver layer 102 and/or the second driver layer 104. During operation of the loudspeaker module 100, the first driver layer 102 and/or the second driver layer 104 causes air inside of the Helmholtz resonator 106 to oscillate to interfere with the sound waves emitted by the first driver layer 102 and/or the second driver layer 104. In these embodiments, when the sound waves emitted by the first driver layer 102 and/or the second driver layer 104 enter the Helmholtz resonator 106, the air inside the Helmholtz resonator 106 oscillates to generate sound waves at substantially similar frequencies. In some embodiments, the sound waves emitted by the Helmholtz resonator 106 can destructively and/or constructively interfere with the sound waves emitted by the first driver layer 102 and/or the second driver layer 104. In these embodiments, the sound waves emitted by the Helmholtz resonator 106 can destructively interfere with the sound waves emitted by the first driver layer 102 and/or the second driver layer 104. In these embodiments, the sound waves emitted by the Helmholtz resonator 106 can constructively interfere with the sound waves emitted by the first driver layer 102 and/or the second driver layer 104. In some embodiments, the Helmholtz resonator 106 can be intelligently constructed to destructively and/or constructively interfere specific frequencies, or ranges of specific frequencies, of the sound waves emitted by the first driver layer 102 and/or the second driver layer 104 as described herein.

Exemplary Helmholtz Resonator that can be Implemented within the Exemplary Loudspeaker Module

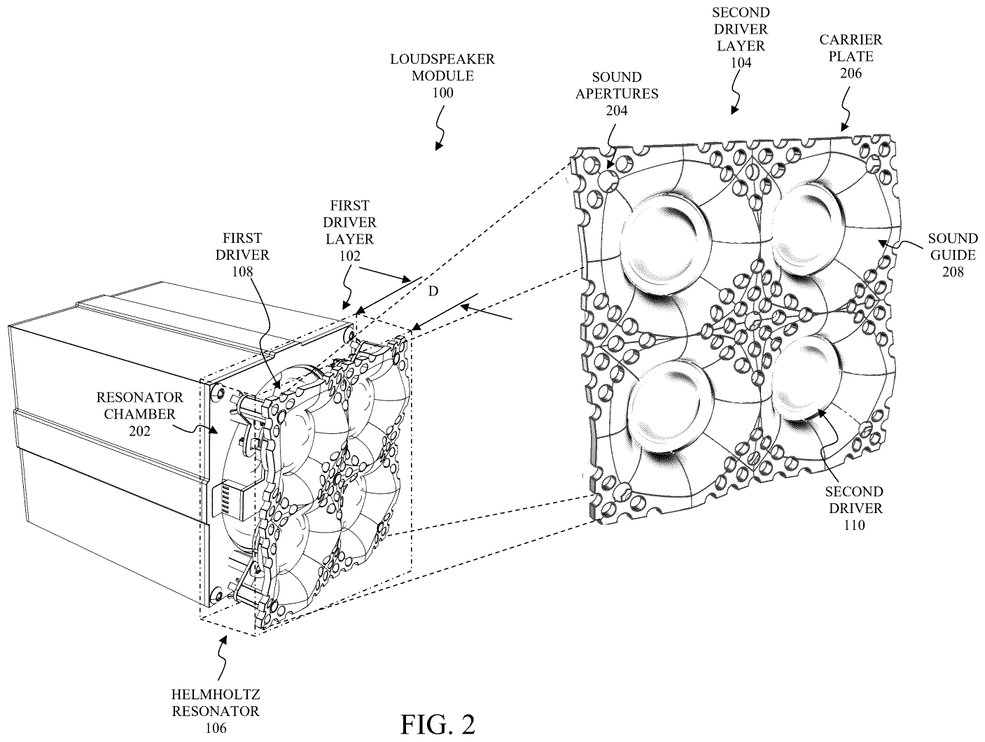

FIG. 2 is a more detailed partial sectional view of the first exemplary loudspeaker module that further illustrates an exemplary Helmholtz resonator that can be implemented within the first exemplary loudspeaker module according to some exemplary embodiments of the present disclosure. As illustrated in FIG. 2, the Helmholtz resonator 106 includes a resonator chamber 202 situated between the first driver layer 102 and the second driver layer 104. In some embodiments, the first driver layer 102 can connect to the second driver layer 104 using one or more fastening elements, such as posts, clamps, anchors, hinges, studs, cleats, braces, hooks, spacers, among other to separate, or displace, the first driver layer 102 and the second driver layer 104 by a displacement distance D. In these embodiments, a volume of the resonator chamber 202 can follow the displacement distance D between the first driver layer 102 and the second driver layer 104. And as described herein, the first driver layer 102 can include one or more first drivers 108 and the second driver layer 104 can include one or more second drivers 110. In some embodiments, these loudspeakers can include drivers, cones or diaphragms, dust caps, voice coils, magnets, suspensions or spiders, baskets or frames, among others. In these embodiments, the volume of the resonator chamber 202 can follow cones and/or dust caps of the one or more first drivers 108 and/or baskets of the one or more second drivers 110. And as illustrated in FIG. 2, the second driver layer 104 includes multiple sound apertures 204 that are connected to resonator chamber 202. In some embodiments, the multiple sound apertures 204 can be configured and arranged to pass through sound waves emitted by the one or more first drivers 108. In these embodiments, some of the multiple sound apertures 204 can situated at or near approximate centers of the one or more first drivers 108. Alternatively, or in addition to, some of the multiple sound apertures 204 can situated along perimeters of the one or more first drivers 108. In some embodiments, the multiple sound apertures 204 represent openings, holes, voids, cavities, hollows, vents, or the like within the second, outer driver layer 104. Although, these openings, holes, voids, cavities, hollows, vents, or the like are illustrated as being cylindrical, or cylinder-like, shapes in FIG. 2, those skilled in the relevant art(s) will recognize that these openings, holes, voids, cavities, hollows, vents, or the like can be any suitable three-dimensional shape, such as a cube, a rectangular prism, a sphere, or a cone, among others, that will be apparent to those skilled in the relevant art(s) without departing from the spirit and scope of the present disclosure. As illustrated in FIG. 2, the second driver layer 104 can include the one or more second drivers 110 that are mounted onto a carrier plate 206. As illustrated in FIG. 2, one or more of the multiple sound apertures 204 can be situated within the carrier plate 206 to draw air into the resonator chamber 202 and/or release air from the resonator chamber 202 as described herein. In some embodiments, the carrier plate 206 can be integrated with one or more sound guides 208 to assist in directing the sound waves emitted by the one or more second drivers 110 as described herein. And as illustrated in FIG. 2, one or more of the multiple sound apertures 204 can be situated within the one or more sound guides 208 to draw air into the resonator chamber 202 and/or release air from the resonator chamber 202 as described herein. In the exemplary embodiment illustrated in FIG. 2, the multiple sound apertures 204 can be configured and arranged to be a diamond, or diamond-like, pattern within the carrier plate 206 and/or the one or more sound guides 208. In some embodiments, the center of the carrier plate 206 includes a diamond, or diamond-like, pattern of twenty-five sound apertures, with the top, bottom, left, and right sides of the carrier plate 206 including half of these sound apertures and the top, bottom, left, and right corners of the carrier plate 206 including a quarter of these sound apertures. However, the configuration and arrangement of the multiple sound apertures 204 illustrated in FIG. 2 is for example purposes only and not limiting. Those skilled in the relevant art(s) will recognize that the second driver layer 104 can include any suitable number of sound apertures that can be configured and arranged to be in any suitable shape, such as a circle, a triangle, a square, a rectangle, a pentagon, a quadrilateral, a hexagon, or an octagon, among others, to provide some examples, or any suitable combination of suitable shapes without departing from the spirit and scope of the present disclosure.

During operation of the loudspeaker module 100, the sound waves emitted by the first driver layer 102 and/or the second driver layer 104 can compress and/or expand the air inside of the resonator chamber 202. In some embodiments, as the sound waves emitted by the first driver layer 102 and/or the second driver layer 104 push the air inside of the multiple sound apertures 204 toward the resonator chamber 202, the air inside of the resonator chamber 202 compresses to increase the pressure within the resonator chamber 202. In some embodiments, as the sound waves emitted by the first driver layer 102 and/or the second driver layer 104 push the air inside of the resonator chamber 202 toward the multiple sound apertures 204, the air inside of the resonator chamber 202 expands to decrease the pressure within the resonator chamber 202. In some embodiments, the back-and-forth compression and expansion of the air inside of the resonator chamber 202 causes the air inside of the resonator chamber 202 to oscillate to generate sound waves at substantially similar frequencies. In some embodiments, the sound waves emitted by the Helmholtz resonator 106 can constructively interfere and/or destructively interfere with the sound waves emitted by the first driver layer 102 and/or the second driver layer 104. In these embodiments, the sound waves emitted by the Helmholtz resonator 106 can be approximately in-phase with the sound waves emitted by the first driver layer 102 and/or the second driver layer 104 to constructively interfere with the sound waves emitted by the first driver layer 102 and/or the second driver layer 104. In these embodiments, because the sound waves emitted by the Helmholtz resonator 106 and the sound waves emitted by the first driver layer 102 and/or the second driver layer 104 are approximately in-phase with respect to one another, the sound waves emitted by the Helmholtz resonator 106 can amplify the sound waves emitted by the first driver layer 102 and/or the second driver layer 104. Alternatively, or in addition to, the sound waves emitted by the Helmholtz resonator 106 can be approximately out-of-phase, for example, approximately one hundred eighty (180) degrees, with the sound waves emitted by the first driver layer 102 and/or the second driver layer 104 to destructively interfere with the sound waves emitted by the first driver layer 102 and/or the second driver layer 104. In these embodiments, because the sound waves emitted by the Helmholtz resonator 106 and the sound waves emitted by the first driver layer 102 and/or the second driver layer 104 are approximately out-of-phase with respect to one another, the sound waves emitted by the Helmholtz resonator 106 can absorb the sound waves emitted by the first driver layer 102 and/or the second driver layer 104.

In some embodiments, the oscillation of the air inside of the resonator chamber 202 and the sound waves emitted by the Helmholtz resonator 106 reaches their maximum when the frequency of the sound waves emitted by the first driver layer 102 and/or the second driver layer 104 matches, or substantially matches, a resonant frequency of the Helmholtz resonator 106. In these embodiments, the Helmholtz resonator 106 can be characterized by a natural frequency at which it oscillates most strongly, also referred to as the resonant frequency. In some embodiments, the interaction between the Helmholtz resonator 106 and the sound waves emitted by the first driver layer 102 and/or the second driver layer 104 is the strongest when these sound waves are at, or near, the resonant frequency. In these embodiments, the sound waves emitted by the Helmholtz resonator 106 can be characterized as being at their maximum sound pressure, or acoustic pressure, when the sound waves emitted by the first driver layer 102 and/or the second driver layer 104 are at, or near, the resonant frequency. In some embodiments, the interaction between the Helmholtz resonator 106 and the sound waves emitted by the first driver layer 102 and/or the second driver layer 104 can weaken as these sound waves move further from the resonant frequency. In these embodiments, the sound pressure, or the acoustic pressure, of the sound waves emitted by the Helmholtz resonator 106 can be characterized as weakening from their maximum as the sound waves emitted by the first driver layer 102 and/or the second driver layer 104 move further from the resonant frequency. In some embodiments, the resonant frequency of the Helmholtz resonator 106 can be approximated as:

$$f = \frac{c}{2 π} \sqrt{\frac{A}{VL}} , \qquad ( 1 )$$

wherein f represents the resonant frequency of the Helmholtz resonator 106, c represents the speed of sound in air, A represents the cross-sectional areas of the multiple sound apertures 204, V represents the volume of the resonator chamber 202, and L represents the effective lengths of the multiple sound apertures 204. In some embodiments, the A represents the cross-sectional areas of the multiple sound apertures 204 can be approximately twenty-five (25) millimeters (mm), the volume of the resonator chamber 202 can be approximately ten (10) centimeters (cm), and/or the effective lengths of the multiple sound apertures 204 can be approximately two (2) millimeters (mm).

### Exemplary Tuning of the Exemplary Loudspeaker Module

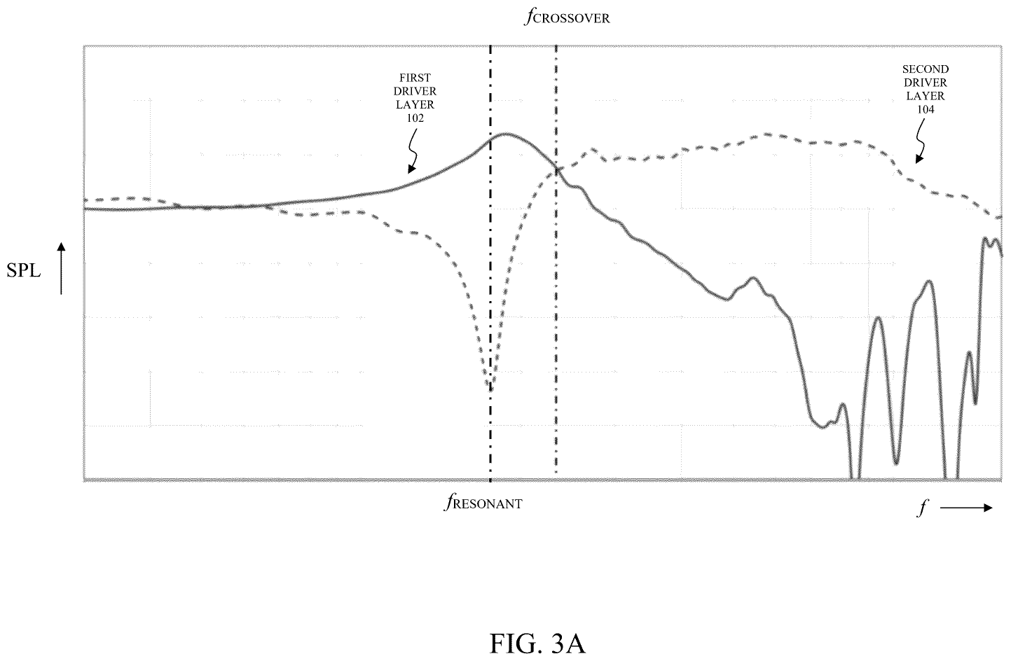

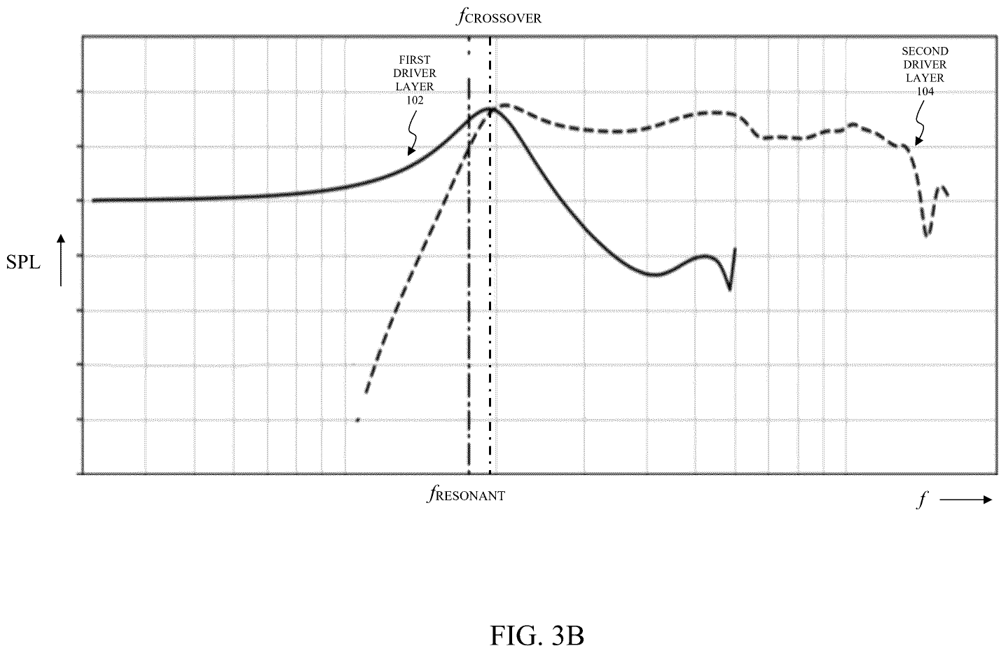

FIG. 3A and FIG. 3B graphically illustrate exemplary tuning of the exemplary loudspeaker module according to some exemplary embodiments of the present disclosure. As described herein, the first driver layer 102 and the second driver layer 104 can be configured and arranged to form a part of the Helmholtz resonator 106 that is situated between these two driver layers. And as described herein, the sound waves emitted by the first driver layer 102 and/or the second driver layer 104 can cause the Helmholtz resonator 106 to oscillate to emitted sound waves. In some embodiments, the sound waves emitted by the Helmholtz resonator 106 can constructively interfere and/or destructively interfere with the sound waves emitted by the first driver layer 102 and/or the second driver layer 104. In these embodiments, the sound waves emitted from the backside, referred to as back waves, of the second driver layer 104 can constructively interfere and/or destructively interfere with the sound waves emitted by the Helmholtz resonator 106. Alternatively, or in addition to, the sound waves emitted from the frontside, referred to as front waves, of the first driver layer 102 can constructively interfere and/or destructively interfere with the sound waves emitted by the Helmholtz resonator 106. In some embodiments, one or more characteristics, parameters, and/or attributes of the first driver layer 102 and/or the second driver layer 104 can determine whether the sound waves emitted by the first driver layer 102 and/or the second driver layer 104, respectively, constructively interfere or destructively interfere with the sound waves emitted by the Helmholtz resonator 106. For example, the sound waves emitted by the first driver layer 102 can constructively interfere with the sound waves emitted by the Helmholtz resonator 106. In this example, the sound waves emitted from the Helmholtz resonator 106 can be characterized as being approximately in-phase with the sound waves emitted by the first driver layer 102 to constructively interfere. As another example, the sound waves emitted by the second driver layer 104 can destructively interfere with the sound waves emitted by the Helmholtz resonator 106. In this example, the sound waves emitted from the Helmholtz resonator 106 can be characterized as being out-of-phase, for example, approximately one hundred eighty (180) degrees, with the sound waves emitted by the second driver layer 102 to destructively interfere with the sound waves emitted by the second driver layer 104.

In the exemplary embodiment illustrated in FIG. 3A and FIG. 3B, the loudspeaker module 100 can be characterized in accordance with a crossover frequency. In some embodiments, the crossover frequency represents a specific frequency, or range of frequencies, at which the sound waves emitted by the loudspeaker module 100 are separated among the first driver layer 102 and the second driver layer 104. In these embodiments, the loudspeaker module 100 can include, or be coupled to, one or more crossover networks to separate the sound waves emitted by the loudspeaker module 100 among the first driver layer 102 and the second driver layer 104. As illustrated in FIG. 3A and FIG. 3B, the sound waves emitted by the loudspeaker module 100 below the crossover frequency f_{CROSSOVER} are emitted by the first driver layer 102 and the sound waves emitted by the loudspeaker module 100 above the crossover frequency f_{CROSSOVER} are emitted by the second driver layer 104. In some embodiments, it can be beneficial to set the timing, or phase, of the first driver layer 102 and the second driver layer 104 to be approximately in-phase with one another at, or near, the crossover frequency f_{CROSSOVER}. In some embodiments, it can be beneficial to tune the Helmholtz resonator 106 as described herein to be characterized as having the resonant frequency f_{RESONANT} that is less than the crossover frequency f_{CROSSOVER} as illustrated in FIG. 3A and FIG. 3B. In these embodiments, the Helmholtz resonator 106 can advantageously constructively interfere the sound waves emitted by the first driver layer 102 at, or near, the resonant frequency f_{RESONANT} of the Helmholtz resonator 106. And the sound waves emitted by the first driver layer 102 are strongly attenuated above the crossover frequency f_{CROSSOVER} as illustrated in FIG. 3A and FIG. 3B.

As illustrated in FIG. 3A, the sound waves emitted by the first driver layer 102 can constructively interfere with the sound waves emitted by the Helmholtz resonator 106. And as described herein the sound waves emitted by the Helmholtz resonator 106 are the strongest at, or near, the resonant frequency f_{RESONANT} of the Helmholtz resonator 106 as illustrated in FIG. 3A. In some embodiments, the sound waves emitted by the first driver layer 102 can constructively interfere with the sound waves emitted by the Helmholtz resonator 106 when the sound waves emitted by the first driver layer 102 are approximately in-phase with the sound waves emitted by the Helmholtz resonator 106 as indicated by sound pressure level (SPL) of the sound waves emitted by the first driver layer 102 at, or near, the resonant frequency f_{RESONANT}. In some embodiments, the Helmholtz resonator 106 constructively interferes with the sound waves emitted by the first driver layer 102 the strongest at, or near, the resonant frequency f_{RESONANT} of the Helmholtz resonator 106 as indicated by the high-point, or peak, of the sound pressure level (SPL) of the sound waves emitted by the first driver layer 102 at, or near, the resonant frequency f_{RESONANT}. And as illustrated in FIG. 3A, the sound waves emitted by the second driver layer 104 can destructively interfere with the sound waves emitted by the Helmholtz resonator 106 when the sound waves emitted by the second driver layer 104 are approximately out-of-phase, for example, approximately one hundred eighty (180) degrees with the sound waves emitted by the Helmholtz resonator 106 as indicated by sound pressure level (SPL) of the sound waves emitted by the second driver layer 104 at, or near, the resonant frequency f_{RESONANT}. In some embodiments, the Helmholtz resonator 106 destructively interferes with the sound waves emitted by the second driver layer 104 at, or near, the resonant frequency f_{RESONANT} of the Helmholtz resonator 106 as indicated by the low-point, or valley, of the sound pressure level (SPL) of the sound waves emitted by the second driver layer 104 at, or near, the resonant frequency f_{RESONANT}.

As illustrated in FIG. 3B, the sound waves emitted by the first driver layer 104 can constructively interfere with the sound waves emitted by the Helmholtz resonator 106. And as described herein the sound waves emitted by the Helmholtz resonator 106 are the strongest at, or near, the resonant frequency f_{RESONANT} of the Helmholtz resonator 106 as illustrated in FIG. 3B. As illustrated in FIG. 3B, the sound waves emitted by the first driver layer 102 can constructively interfere with the sound waves emitted by the Helmholtz resonator 106 when the front waves of the sound waves emitted by the first driver layer 102 are approximately in-phase with the front waves of the sound waves emitted by the first driver layer 102 as indicated by sound pressure level (SPL) of the sound waves emitted by the first driver layer 102 at, or near, the resonant frequency f_{RESONANT}. In some embodiments, the Helmholtz resonator 106 amplifies the sound waves emitted by the first driver layer 102 at, or near, the resonant frequency f_{RESONANT} of the Helmholtz resonator 106 as indicated by the high-point, or peak, of the sound pressure level (SPL) of the sound waves emitted by the first driver layer 102 at, or near, the resonant frequency f_{RESONANT}. In some embodiments, it can be beneficial for the mechanical enclosure 112 to include one or more openings, holes, voids, cavities, hollows, vents, or the like between the first driver layer 102 and the second driver layer 104 to allow the sound waves emitted by the first driver layer 102 to radiate away from the first driver layer 102. And as illustrated in FIG. 3B, the sound waves emitted by the second driver layer 104 can constructively interfere with the sound waves emitted by the Helmholtz resonator 106 when the sound waves emitted by the second driver layer 104 are approximately in-phase with the sound waves emitted by the Helmholtz resonator 106 as indicated by sound pressure level (SPL) of the sound waves emitted by the second driver layer 104 at, or near, the resonant frequency f_{RESONANT}. In some embodiments, the Helmholtz resonator 106 constructively interferes the sound waves emitted by the second driver layer 104 the strongest at, or near, the resonant frequency f_{RESONANT} of the Helmholtz resonator 106 as indicated by the high-point, or peak, of the sound pressure level (SPL) of the sound waves emitted by the second driver layer 104 at, or near, the resonant frequency f_{RESONANT}. In these embodiments, the Helmholtz resonator 106 can be characterized as extending the frequency response of the second driver layer 104 to lower frequencies when constructively interfering the sound waves emitted by the second driver layer 104.

As described herein, the Helmholtz resonator 106 can amplify and/or absorb the sound waves emitted by the second driver layer 104. As illustrated in FIG. 3A, the Helmholtz resonator 106 destructively interferes with the second driver layer 104 in response to the sound waves emitted by the second driver layer 104 being approximately out-of-phase, for example, approximately one hundred eighty (180) degrees, with the sound waves emitted by the Helmholtz resonator 106. In some embodiments, the sound waves emitted by the Helmholtz resonator 106 can be characterized as being approximately out-of-phase, for example, approximately one hundred eighty (180) degrees, with the sound waves emitted by the second driver layer 104 to destructively interfere with the sound waves emitted by the second driver layer 104. In some embodiments, the one or more second drivers 110 can be implemented using, for example, dipole drivers, omnidirectional drivers, monopole drivers with reflective baffles, and/or multi-driver array drivers, among others. Alternatively, or in addition to, the Helmholtz resonator 106 constructively interferes with the sound waves emitted by the second driver layer 104 in response to sound waves emitted by the second driver layer 104 being approximately in-phase with the sound waves emitted by the second driver layer 104. In some embodiments, the sound waves emitted by the Helmholtz resonator 106 can be characterized as being approximately in-phase with the sound waves emitted by the second driver layer 104 to constructively interfere with the sound waves emitted by the second driver layer 104. In some embodiments, the one or more second drivers 110 can be implemented using, for example, dipole drivers.

### Second Exemplary Loudspeaker Module

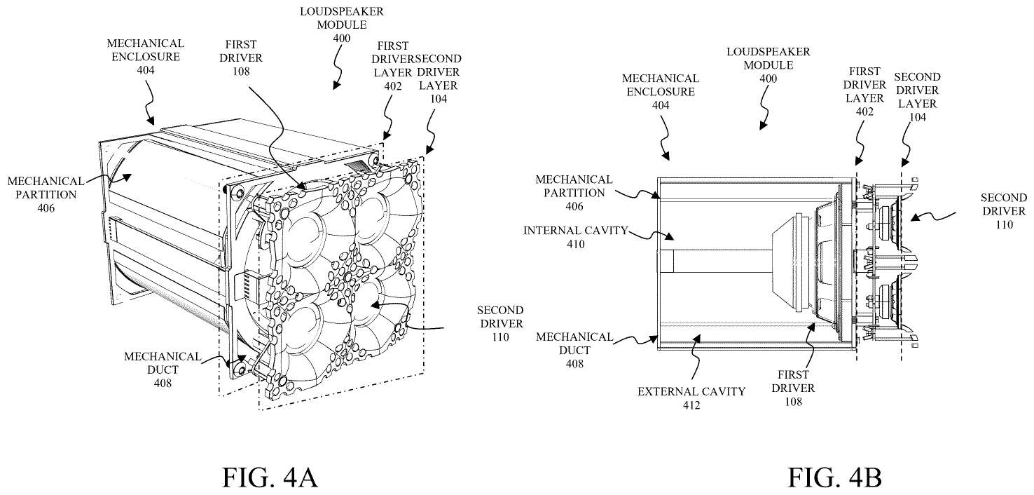

FIG. 4A and FIG. 4B illustrate a partial sectional view of a second exemplary loudspeaker module according to some exemplary embodiments of the present disclosure. FIG. 4A graphically illustrates a perspective view of a loudspeaker module 400 and FIG. 4B graphically illustrates a side view of the loudspeaker module 400. In the exemplary embodiment illustrated in FIG. 4A and FIG. 4B, the loudspeaker module 400 represents a multi-dimensional loudspeaker module having wave field synthesis (WFS) and/or beamforming capabilities. In some embodiments, the loudspeaker module 400 can emit precisely controlled sound waves in a three-dimensional space, such as the venue described herein, to create the highly localized and customizable audio zones in a substantially similar manner as the loudspeaker module 100 as described herein. In some embodiments, multiple loudspeaker modules 400 can be coupled together in a horizontal direction and/or a vertical direction to form a loudspeaker array. As illustrated in FIG. 4A and FIG. 4B, the loudspeaker module 400 includes a first driver layer 402 and the second driver layer 104 as described herein. The loudspeaker module 400 and the loudspeaker module 100 include many substantially similar features as one another as described herein. As such, only differences between the loudspeaker module 100 and the loudspeaker module 400 are to be described in further detail.

In some embodiments, the first driver layer 402 represents an inner, first driver layer having the one or more first drivers 108. As illustrated in FIG. 4A and FIG. 4B, the one or more first drivers 108 can be situated within a mechanical enclosure 404. In these embodiments, the mechanical enclosure 404 can be implemented using dense, rigid materials, such as one or more metals, one or more plastic materials, one or more resin materials, one or more composite materials, one or more ceramic materials, and/or one or more fiberglass materials, among others, to provide some examples. Generally, the mechanical enclosure 404 can shape the quality, the efficiency, and/or the precision of the sound waves generated by the one or more first drivers 108. In some embodiments, the mechanical enclosure 404 can be beneficially designed to minimize sound distortions and prevent unwanted vibrations in the loudspeaker module 100. In these embodiments, the mechanical enclosure 404 can be characterized as containing sound waves emitted from the backside, referred to as back waves, of the one or more first drivers 108 to prevent these back waves from interfering with sound waves emitted from the frontside, referred to as front waves, of the one or more first drivers 108. In some embodiments, the one or more first drivers 108 can be situated within an internal cavity 410, also referred to as an internal volume, of the mechanical enclosure 404. In these embodiments, the size and/or the shape of the internal cavity 410 can affect the acoustic characteristics of the one or more first drivers 108, for example, their frequency response and/or overall sound quality. As illustrated in FIG. 4A and FIG. 4B, the mechanical enclosure 404 can include a mechanical partition 406 to size and/or to shape the internal cavity 410. Although the mechanical partition 406 is illustrated in FIG. 4A and FIG. 4B as being a cylindrical, or cylinder-like, shape in FIG. 4A and FIG. 4B, those skilled in the relevant art(s) will recognize that the mechanical partition 406 can size and/or shape the internal cavity 410 to be any suitable three-dimensional shape, such as a cube, a rectangular prism, a sphere, or a cone, among others, that will be apparent to those skilled in the relevant art(s) without departing from the spirit and scope of the present disclosure. In these embodiments, the mechanical partition 406 can be implemented using dense, rigid materials, such as one or more metals, one or more plastic materials, one or more resin materials, one or more composite materials, one or more ceramic materials, and/or one or more fiberglass materials, among others, to provide some examples.

As illustrated in FIG. 4A and FIG. 4B, the mechanical enclosure 404 can include one or more mechanical ducts 408 to implement one or more ports for a ported enclosure as described herein. In some embodiments, the mechanical enclosure 404 can include an external cavity 412, also referred to as an external volume, in relation to the mechanical partition 406 that effectively surrounds the mechanical partition 406. In these embodiments, the size and/or the shape of the external cavity 412 can affect the acoustic characteristics of the one or more first drivers 108, for example, their frequency response and/or overall sound quality. In some embodiments, the mechanical enclosure 404 can include one or more mechanical ducts 408. In some embodiments, the one or more mechanical ducts 408 represent openings, holes, voids, cavities, hollows, vents, or the like within the mechanical enclosure 404. In some embodiments, the one or more mechanical ducts 408 can be situated within a flat panel, or a nearly-flat panel, often referred to as a baffle, of the mechanical enclosure 404 that mounts the one or more first drivers 108 to the mechanical enclosure 404. Alternatively, or in addition to, the one or more mechanical ducts 408 can be situated within a rear enclosure, opposite of the baffle, of the mechanical enclosure 404. In some embodiments, the one or more mechanical ducts 408 allow air to pass through the mechanical enclosure 404 via the external cavity 412. In these embodiments, the baffle can be secured to the rear enclosure using various fasteners, such as nuts, screws, bolts, rivets, pins, and/or lags, among others, to provide some examples.

### Third Exemplary Loudspeaker Module

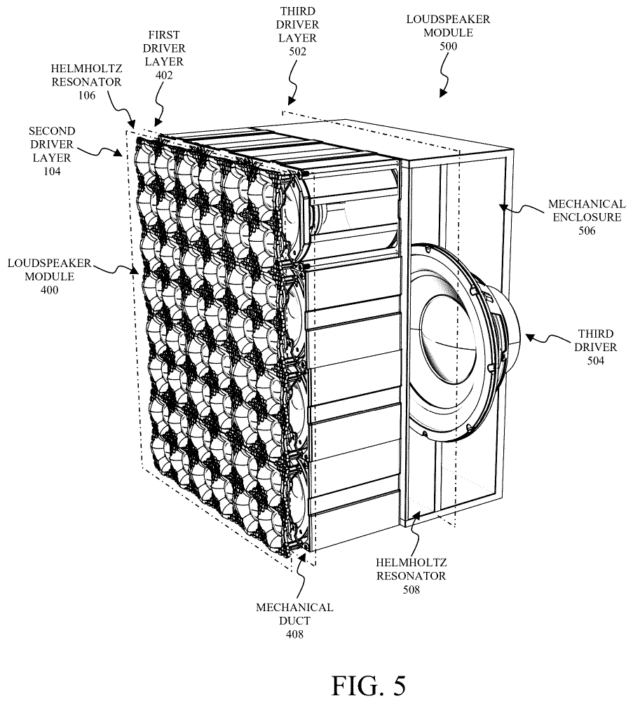

FIG. 5 illustrates a partial sectional view of a third exemplary loudspeaker module according to some exemplary embodiments of the present disclosure. In the exemplary embodiment illustrated in FIG. 5, a loudspeaker module 500 represents a multi-dimensional loudspeaker module having wave field synthesis (WFS) and/or beamforming capabilities. In some embodiments, the loudspeaker module 500 can emit precisely controlled sound waves in a three-dimensional space, such as the venue described herein, to create the highly localized and customizable audio zones in a substantially similar manner as the loudspeaker module 100 as described herein. In some embodiments, multiple loudspeaker modules 500 can be coupled together in a horizontal direction and/or a vertical direction to form a loudspeaker array. As illustrated in FIG. 5, the loudspeaker module 500 includes the loudspeaker module 400 having the first driver layer 402 and the second driver layer 104 as described herein and a third driver layer 502. In the exemplary embodiment illustrated in FIG. 5, the first driver layer 402 and the second driver layer 104 can be configured and arranged to form the Helmholtz resonator 106 as described herein and/or the first driver layer 402 and the third driver layer 502 can be configured and arranged to form the Helmholtz resonator 508. And as illustrated in FIG. 5, the first driver layer 402 and the third driver layer 502 can be configured and arranged to form a Helmholtz resonator 508 that is situated between these two driver layers, for example, within one or more openings, holes, voids, cavities, hollows, vents, or the like between the first driver layer 402 and the third driver layer 502. In some embodiments, the Helmholtz resonator 508 can further include one or more openings, holes, voids, cavities, hollows, vents, or the like within the first driver layer 402, for example, the one or more mechanical ducts 408. Generally, the sound waves emitted by the first driver layer 402 and/or the third driver layer 502 can cause the Helmholtz resonator 508 to oscillate to generate sound waves that interfere, for example, constructively and/or deconstructively, with the sound waves emitted by the first driver layer 402 and/or the third driver layer 502. In these embodiments, the loudspeaker module 500 can advantageously control the sound waves emitted by the Helmholtz resonator 508 to constructively and/or destructively interfere with the sound waves emitted by the first driver layer 402 and/or the third driver layer 502 as described herein. The loudspeaker module 500, the loudspeaker module 400, and/or the loudspeaker module 100 include many substantially similar features as one another as described herein. As such, only differences between the loudspeaker module 500, the loudspeaker module 400, and/or the loudspeaker module 100 are to be described in further detail.

In some embodiments, the third driver layer 502 represents an innermost, third driver layer having one or more third drivers 504. In these embodiments, the one or more third drivers 504 can include one or more low-frequency drivers, such as one or more woofers, and/or one or more subwoofers to provide some examples. In some embodiments, the one or more third loudspeakers 506 can be situated within a mechanical enclosure 506, for example, a sealed enclosure or a ported enclosure. In these embodiments, the mechanical enclosure 506 can be implemented using dense, rigid materials, such as one or more metals, one or more plastic materials, one or more resin materials, one or more composite materials, one or more ceramic materials, and/or one or more fiberglass materials, among others, to provide some examples. Generally, the mechanical enclosure 506 can shape the quality, the efficiency, and/or the precision of the sound waves generated by the one or more third loudspeakers 506. In some embodiments, the mechanical enclosure 506 can be beneficially designed to minimize sound distortions and prevent unwanted vibrations in the loudspeaker module 500. In these embodiments, the mechanical enclosure 506 can be characterized as containing sound waves emitted from the backside, referred to as back waves, of the one or more third loudspeakers 506 to prevent these back waves from interfering with sound waves emitted from the frontside, referred to as front waves, of the one or more third loudspeakers 506. In some embodiments, the one or more third loudspeakers 506 can be situated within an internal cavity, also referred to as an internal volume, of the mechanical enclosure 506. In these embodiments, the size and/or the shape of the internal cavity can affect the acoustic characteristics of the one or more third loudspeakers 506, for example, their frequency response and/or overall sound quality. In some embodiments, the mechanical enclosure 506 can include a flat panel, or a nearly-flat panel, often referred to as a baffle, for mounting the one or more third loudspeakers 506 to the mechanical enclosure 506. In these embodiments, the one or more third loudspeakers 506 can be secured to the baffle using various fasteners, such as nuts, screws, bolts, rivets, pins, and/or lags, among others, to provide some examples. In some embodiments, sealant or other gaskets can be utilized to secure the one or more third loudspeakers 506 to the baffle to, for example, prevent air leaks and minimize vibrations that can affect sound quality.

As illustrated in FIG. 5, the Helmholtz resonator 508 can include openings, holes, voids, cavities, hollows, vents, or the like that are formed between the first driver layer 402 and the third driver layer 502 and one or more openings, holes, voids, cavities, hollows, vents, or the like within the first driver layer 402, for example, the one or more mechanical ducts 408. In some embodiments, the Helmholtz resonator 508 can beneficially control the sound waves emitted by the first driver layer 402 and/or the third driver layer 502. In these embodiments, the Helmholtz resonator 508 can interfere, for example, constructively and/or deconstructively, the sound waves emitted by the first driver layer 402 and/or the third driver layer 502. During operation of the loudspeaker module 500, the first driver layer 402 and/or the third driver layer 502 causes air inside of the Helmholtz resonator 508 to oscillate to interfere with the sound waves emitted by the first driver layer 402 and/or the third driver layer 502. In these embodiments, when the sound waves emitted by the first driver layer 402 and/or the third driver layer 502 enter the Helmholtz resonator 508, the air inside the Helmholtz resonator 508 oscillates to generate sound waves at substantially similar frequencies. In some embodiments, the sound waves emitted by the Helmholtz resonator 508 can destructively and/or constructively interfere with the sound waves emitted by the first driver layer 402 and/or the third driver layer 502. In these embodiments, the sound waves emitted by the Helmholtz resonator 508 can destructively interfere with the sound waves emitted by the first driver layer 402 and/or the third driver layer 502. In these embodiments, the sound waves emitted by the Helmholtz resonator 508 can constructively interfere with the sound waves emitted by the first driver layer 402 and/or the third driver layer 502. In some embodiments, the Helmholtz resonator 508 can be intelligently constructed to destructively and/or constructively interfere specific frequencies, or ranges of specific frequencies, of the sound waves emitted by the first driver layer 402 and/or the third driver layer 502 as described herein.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A loudspeaker module, comprising:
a first driver layer configured to emit one or more first sound waves; and
a second driver layer configured to emit one or more second sound waves, the second driver layer including a plurality of sound apertures that are connected to a resonator chamber, the resonator chamber being situated between the first driver layer and the second driver layer,
wherein the resonator chamber and the plurality of sound apertures are configured and arranged to form a Helmholtz resonator that configured to emit one or more third sound waves that interfere with the one or more first sound waves or the one or more second sound waves.

2. The loudspeaker module of claim 1, wherein the first driver layer comprises one or more low-frequency drivers configured to emit the one or more first sound waves, and
wherein the second driver layer comprises one or more high-frequency drivers configured to emit the one or more second sound waves.

3. The loudspeaker module of claim 1, wherein the one or more first sound waves or the one or more second waves have been shaped in accordance with wave field synthesis (WFS) or beamforming techniques.

4. The loudspeaker module of claim 1, wherein the one or more third sound waves are configured to constructively interfere or deconstructively interfere with the one or more first sound waves.

5. The loudspeaker module of claim 2, wherein the one or more first sound waves and the one or more third sound waves are configured to be in-phase with one another to constructively interfere with one another or to be out-of-phase with one another to destructively interfere with one another.

6. The loudspeaker module of claim 1, wherein the one or more third sound waves are configured to constructively interfere or deconstructively interfere with the one or more second sound waves.

7. The loudspeaker module of claim 6, wherein the one or more second sound waves and the one or more third sound waves are configured to be in-phase with one another to constructively interfere with one another or to be out-of-phase with one another to destructively interfere with one another.

8. The loudspeaker module of claim 1, wherein the plurality of sound apertures comprise a plurality of openings, holes, voids, cavities, hollows, or vents with the second driver layer that connect to the resonator chamber, the plurality of openings, holes, voids, cavities, hollows, or vents being configured to draw air from the resonant chamber and release air from the resonant chamber.

9. A loudspeaker module, comprising:
a first plurality of drivers, situated within a mechanical enclosure, configured to emit one or more first sound waves; and
a second plurality of drivers, mounted onto a carrier plate, configured to emit one or more second sound waves, the second plurality of drivers being installed within one or more sound guides integrated onto the carrier plate, the carrier plate including a plurality of sound apertures that are connected to a resonator chamber, the resonator chamber being situated between the mechanical enclosure layer and the carrier plate,
wherein the resonator chamber and the plurality of sound apertures are configured and arranged to form a Helmholtz resonator that is configured to emit one or more third sound waves that interfere with the one or more first sound waves or the one or more second sound waves.

10. The loudspeaker module of claim 9, wherein the one or more first sound waves or the one or more second waves have been shaped in accordance with wave field synthesis (WFS) or beamforming techniques.

11. The loudspeaker module of claim 9, wherein the one or more third sound waves are configured to constructively interfere or deconstructively interfere with the one or more first sound waves.

12. The loudspeaker module of claim 11, wherein the one or more first sound waves and the one or more third sound waves are configured to be in-phase with one another to constructively interfere with one another or to be out-of-phase with one another to destructively interfere with one another.

13. The loudspeaker module of claim 9, wherein the one or more third sound waves are configured to constructively interfere or deconstructively interfere with the one or more second sound waves.

14. The loudspeaker module of claim 13, wherein the one or more second sound waves and the one or more third sound waves are configured to be in-phase with one another to constructively interfere with one another or to be out-of-phase with one another to destructively interfere with one another.

15. The loudspeaker module of claim 9, wherein the plurality of sound apertures comprise a plurality of openings, holes, voids, cavities, hollows, or vents with the second driver layer that connect to the resonator chamber, the plurality of openings, holes, voids, cavities, hollows, or vents being configured to draw air from the resonant chamber and release air from the resonant chamber.

16. A loudspeaker module having wave field synthesis (WFS) and beamforming capabilities, the loudspeaker module comprising:
one or more woofers, situated within a mechanical enclosure, configured to emit one or more first sound waves; and
one or more tweeters, mounted onto a carrier plate, configured to emit one or more second sound waves that have been shaped in accordance with WFS and beamforming techniques to provide the WFS and beamforming capabilities, the one or more tweeters being installed within one or more sound guides integrated onto the carrier plate, the carrier plate including a plurality of sound apertures that are connected to a resonator chamber, the resonator chamber being situated between the mechanical enclosure layer and the carrier plate,
wherein the resonator chamber and the plurality of sound apertures are configured and arranged to form a Helmholtz resonator that is configured to emit one or more third sound waves that interfere with the one or more first sound waves or the one or more second sound waves.

17. The loudspeaker module of claim 16, wherein the one or more third sound waves are configured to constructively interfere or deconstructively interfere with the one or more first sound waves.

18. The loudspeaker module of claim 17, wherein the one or more first sound waves and the one or more third sound waves are configured to be in-phase with one another to constructively interfere with one another or to be out-of-phase with one another to destructively interfere with one another.

19. The loudspeaker module of claim 16, wherein the one or more third sound waves are configured to constructively interfere or deconstructively interfere with the one or more second sound waves.

20. The loudspeaker module of claim 19, wherein the one or more second sound waves and the one or more third sound waves are configured to be in-phase with one another to constructively interfere with one another or to be out-of-phase with one another to destructively interfere with one another.
